(19) United States
(12) Patent Application Publication
(10) Pub. No.: US 2014/0157547 A1
(43) Pub. Date: Jun. 12, 2014

(54) GRAVITY-BALANCING DEVICE FOR ELECTRIC ROLLER SHADE LIFTING SYSTEM

(71) Applicant: CHICOLOGY, INC., Ontario (CA)

(72) Inventor: JU-HUAI CHEN, ERSHUI TOWNSHIP (TW)

(73) Assignee: CHICOLOGY, INC., Ontario (CA)

(21) Appl. No.: 13/707,627

(22) Filed: Dec. 7, 2012

(51) Int. Cl. E06B 9/62

(52) U.S. Cl. CPC E06B 9/62
USPC 16/400

(57) ABSTRACT

A gravity-balancing device mounted to a head roller of an electric roller shade includes a mounting bracket, a spiral elastic element mounted to the mounting bracket, and a winding element rotatably mounted to the mounting bracket to locate adjacent to the spiral elastic element and connect to the head roller. The spiral elastic element has a fixing end connected to the mounting bracket and a connecting end connected to the winding element. When the head roller is driven by a motor of the electric roller shade to rotate and lower a shade fabric of the roller shade, the gravity-balancing device synchronously generates an upward winding force to the head roller to offset a gravitational force lowering the shade fabric, so that the motor can drive the head roller to rotate reversely and lift the shade fabric with reduced motor torque output to save power and extend the motor life.

### FIELD OF TECHNOLOGY

The present invention relates to a gravity-balancing device for electric roller shade lifting system, and more particularly to a gravity-balancing device mounted to an end of a head roller of an electric roller shade for balancing a force of upward winding the roller shade and a gravitational force lowering the roller shade, so that the electric roller shade can stay at a desired height position without lowering further when a motor thereof stops operating.

### BACKGROUND

Many conventional window shades, such as the Roman shades, have a shade fabric that can be vertically lifted or lowered. These vertically operable window shades usually include a head rail, a lifting unit and a shade fabric connected to and hung from the head rail. The head rail is mounted to an upper edge of a window; the lifting unit includes a plurality of pull cords; and the shade fabric has an upper edge connected to the head rail and a lower edge vertically movable upward or downward. The pull cords are usually hung from the head rail to locate at one lateral side of the window shade and can be easily accessed by a small child. The small child playing near the window shade is subject to the danger of being unexpectedly strangulated by the pull cords. Therefore, the exposed pull cords of the window shades form a big potential threat to the safety of small children. In addition, the pull cords also tend to tangle with one another to cause inconveniences in use.

To solve the above problems in the conventional window shades, many types of cordless electric roller shades have been developed and introduced into market. FIGS. 1 and 2 show a currently available electric roller shade that includes a servomotor 20 mounted to an end of a head roller 10 to provide the power needed to operate the roller shades. When a user pushes a button on a corresponding remote control unit, the servomotor 20 is started and drives the head roller 10 to rotate about its axis, so that a shade fabric 30 is wound around the head roller 10 and lifted or is unwound from the head roller 10 and lowered. The conventional roller shade also includes a lower bar 40, which is connected to a lower edge of the shade fabric and has a certain weight. Therefore, the servomotor 20 for the conventional electric roller shade must have a relatively large torque output to provide sufficient power for rotating the head roller 10 to wind and accordingly lift the shade fabric 30. The servomotor 20 with large torque output inevitably consumes more power and has shortened service life. And, to well control the shade fabric 30 to different height positions, it is necessary to use the relatively expensive servomotor 20, resulting in increased manufacturing cost of the conventional electric roller shade.

It is therefore desirable to overcome the problems in the conventional electric roller shade and to achieve the purposes of saving electric power and extending the service life of motor.

In view of the above problems in the conventional electric roller shade, the inventor has developed a gravity-balancing device for electric roller shade lifting system to enable lifting of a shade fabric of the electric roller shade with a reduced motor torque output.

### SUMMARY

A primary object of the present invention is to provide a gravity-balancing device for electric roller shade lifting system. The gravity-balancing device is able to generate an upward winding force to a head roller of an electric roller shade when the head roller is driven by a motor of the roller shade to rotate and lower a shade fabric of the roller shade. The upward winding force offsets a gravitational force lowering the shade fabric, so that the motor can drive the head roller to rotate reversely and lift the shade fabric with a reduced motor torque output, and the shade fabric can stay at a desired height position without lowering further when the motor stops operating.

To achieve the above and other objects, the gravity-balancing device for electric roller shade lifting system according to a preferred embodiment of the present invention is mounted to a first end of a head roller of an electric roller shade and includes a mounting bracket, a spiral elastic element mounted to a first supporting section of the mounting bracket, and a winding element rotatably mounted to a second supporting section of the mounting bracket to locate adjacent to the spiral elastic element and connect to the head roller of the electric roller shade. The spiral elastic element has a fixing end connected to the mounting bracket and a connecting end connected to the winding element. When a motor mounted to an opposite second end of the head roller drives the head roller to rotate and lower a shade fabric of the roller shade, the gravity-balancing device synchronously generates an upward winding force to the head roller to offset a gravitational force lowering the shade fabric, so that the shade fabric can be rewound and lifted with reduced motor torque output to save electric power and extend the motor service life.

According to the preferred embodiment of the gravity-balancing device, the winding element includes a spindle and a reel. The spindle is rotatably mounted on the second supporting section of the mounting bracket, and the reel is connected to the spindle.

According to the preferred embodiment of the gravity-balancing device, the connecting end of the spiral elastic element is connected to the reel of the winding element.

According to the preferred embodiment of the gravity-balancing device, two stoppers are further included for clamping to two opposite lateral sides of the spiral elastic element.

According to the preferred embodiment of the gravity-balancing device, a coupled axle is further included. The coupled axle has an end connected to the winding element and another opposite end connected to the first end of the head roller.

According to the preferred embodiment of the gravity-balancing device, a case is further included and assembled to an inner side of the mounting bracket for covering the spiral elastic element and the winding element in between the case and the mounting bracket. The spindle of the winding element is extended through the case to connect to the first end of the head roller.

According to the preferred embodiment of the gravity-balancing device, the first supporting section has a first shaft connected thereto and the second supporting section has a second shaft connected thereto. The fixing end of the spiral elastic element is connected to the first shaft, and the winding element is rotatably fitted around the second shaft.

According to the gravity-balancing device of the present invention, the winding element is synchronously brought to rotate when the head roller of the electric roller shade is driven by the motor to rotate and vertically lower the shade fabric, such that the reel with the connecting end of the spiral elastic element connected thereto synchronously pulls the elastic strip or string of the spiral elastic element and winds the same therearound. At this point, due to a spring force of the elastic strip or string, the spiral elastic element generates a counter-force to the winding element and the head roller. As a result, the head roller has an upward winding force that balances or offsets a gravitational force lowering the shade fabric, enabling a balance between the weight of the shade fabric and the counter-force of the spiral elastic element. Thus, the shade fabric can stay at the same height position without lowering further at the instant the motor stops operating. Therefore, the motor can drive the head roller to rotate reversely and lift the shade fabric with a reduced motor torque output to save electric power and extend motor service life.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional electric roller shade in a fully mounted state;

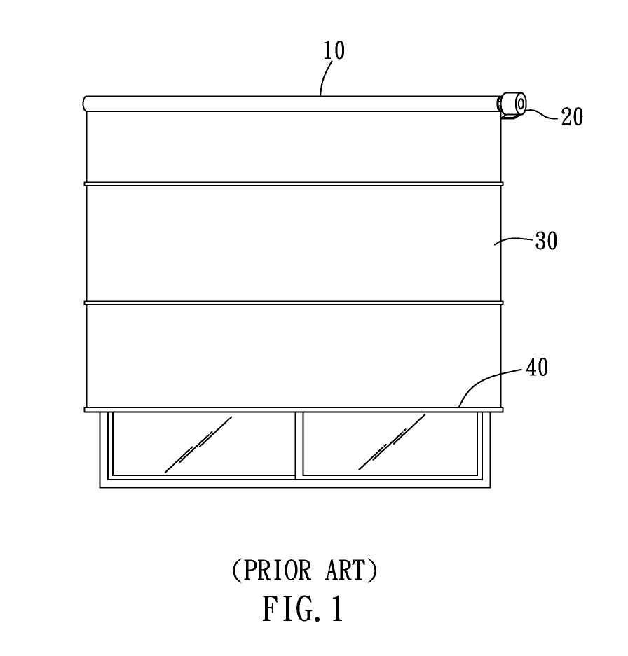

FIG. 2 is a fragmentary and partially exploded perspective view of the conventional electric roller shade of FIG. 1;

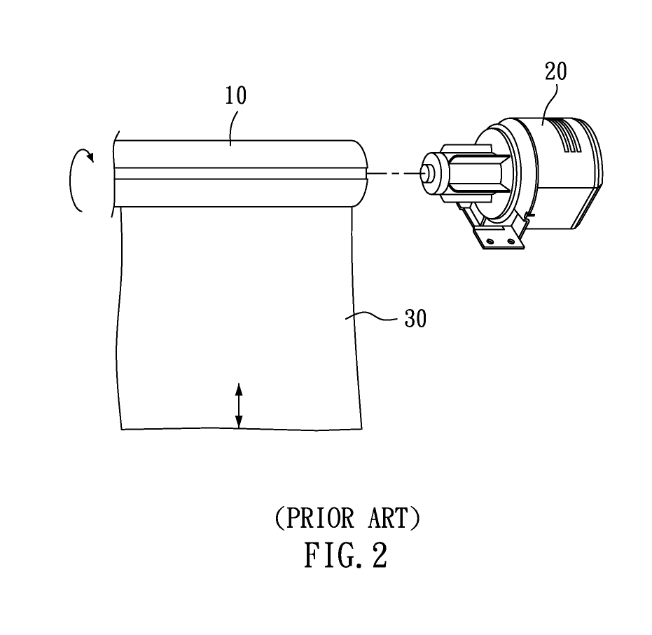

FIG. 3 is an exploded perspective view showing a gravity-balancing device for electric roller shade lifting system according to a preferred embodiment of the present invention;

FIG. 4 is an assembled sectional view of the gravity-balancing device for electric roller shade lifting system according to a preferred embodiment of the present invention; and

FIG. 5 is a phantom view of FIG. 3 in an assembled state showing the lifting and lowering of an electric roller shade equipped with the gravity-balancing device of the present invention.

### DETAILED DESCRIPTION

The present invention will now be described with a preferred embodiment thereof and with reference to the accompanying drawings.

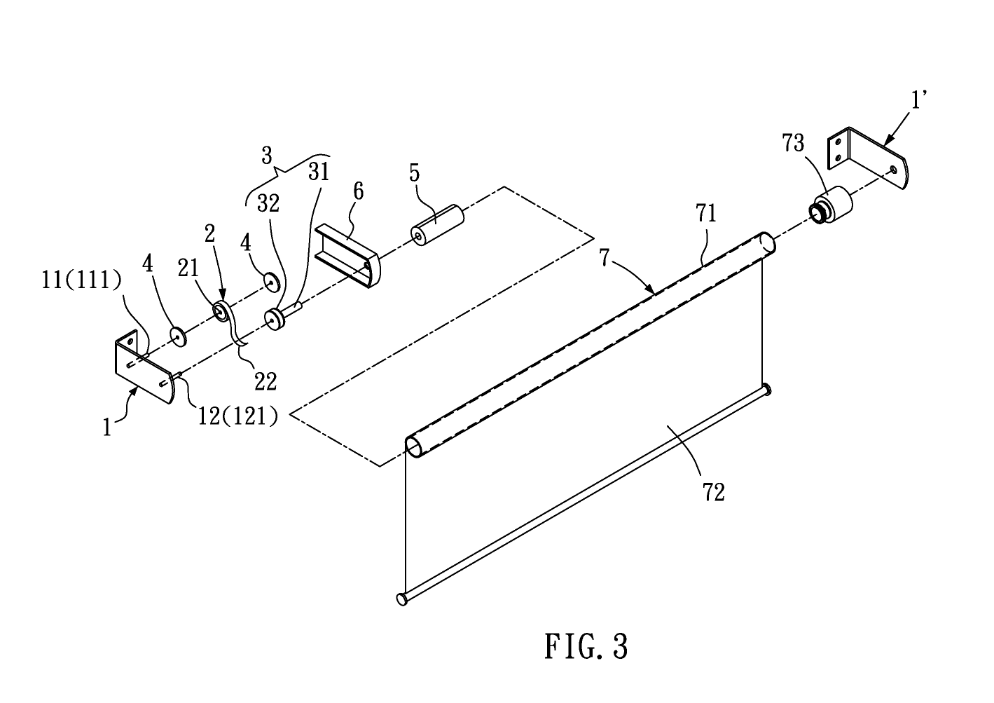

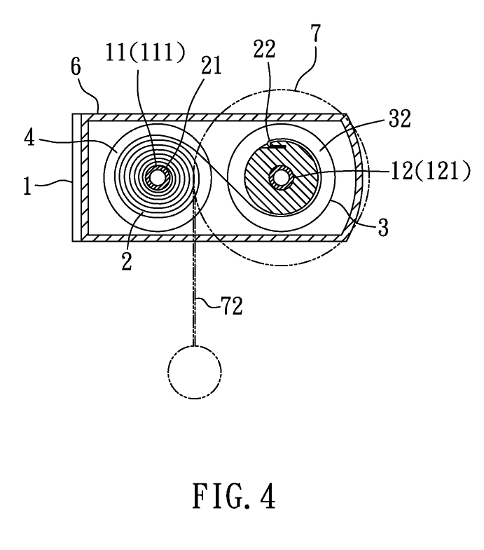

Please refer to FIGS. 3 and 4 that are exploded perspective and assembled sectional views, respectively, of a gravity-balancing device for electric roller shade lifting system according to a preferred embodiment of the present invention. For the purpose of conciseness, the present invention is also briefly referred to as “the brevity-balancing device” herein. As shown, the gravity-balancing device is mounted to a first end of a roller 71 of an electric roller shade 7. When the head roller 71 is rotated to lower a shade fabric 72 of the roller shade 7, the gravity-balancing device correspondingly generates an upward winding force, which balances or offsets a gravitational force that downwardly lowers or unwinds the shade fabric 72, so that a motor 73 mounted to an opposite second end of the head roller 71 needs only to output a reduced torque for lifting the shade fabric 72. According to the preferred embodiment of the present invention, the gravity-balancing device includes a mounting bracket 1, a spiral elastic element 2 mounted to a first supporting section 11 of the mounting bracket 1, and a winding element 3 rotatably mounted to a second supporting section 12 of the mounting bracket 1. The mounting bracket 1 is connected to the first end of the head roller 71 of the electric roller shade 7. Another mounting bracket 1′ can be optionally connected to the second end of the head roller 71, so that the head roller 71 is rotatably located between the two mounting brackets 1, 1′. The spiral elastic element 2 is a spiral spring formed by winding an elastic strip or string into a coil. The spiral elastic element 2 includes a fixing end 21 located at a center of the spiral spring and connected to the first supporting section 11, and an opposite connecting end 22 connected to the winding element 3, so that the elastic strip or string can be pulled to wind around the winding element 3 when the latter is rotated. The winding element 3 is connected to the first end of the head roller 71 and located adjacent to the spiral elastic element 2. The winding element 3 includes a spindle 31 and a reel 32. The spindle 31 is rotatably mounted on the second supporting section 12 of the mounting bracket 1, and can be directly or indirectly connected to the head roller 71. The reel 32 is a wheel-like member integrally formed on or additionally connected to an end of the spindle 31. The connecting end 22 of the spiral elastic element 2 is connected to the reel 32 of the winding element 3, such that the elastic strip or string of the spiral elastic element 2 is wound around the reel 32 when the winding element 3 rotates.

Please refer to FIGS. 3 and 4 at the same time. The first supporting section 11 has a first shaft 111 connected thereto, and the second supporting section 12 has a second shaft 121 connected thereto. The first shaft 111 is located on an inner side of the mounting bracket 1 and adjacent to the head roller 71; and the second shaft 121 is also located on the inner side of the mounting bracket 1 to parallelly space from the first shaft 111. The fixing end 21 of the spiral elastic element 2 is connected to the first shaft 111, and the winding element 3, including the spindle 31 and the reel 32 thereof, is rotatably fitted around the second shaft 121, such that the spiral elastic element 2 is located adjacent to the winding element 3 with the connecting end 22 of the spiral elastic element 2 connected to the reel 32.

As can be seen in FIG. 3, the gravity-balancing device according to the preferred embodiment of the present invention further includes two stoppers 4, which may be two round disks clamped to two opposite lateral sides of the spiral elastic element 2 to ensure that the connecting end 22 of the spiral elastic element 2 can be smoothly wound around the reel 32 of the winding element 3 and that the spiral elastic element 2 can maintain its original coil shape after being rewound again. Moreover, for the winding element 3 to easily connect to and synchronously rotate along with the head roller 71, the gravity-balancing device further includes a coupled axle 5. The coupled axle 5 has an end connected to the spindle 31 of the winding element 3 and another opposite end connected to or fitted in the first end of the head roller 71.

As can be seen in FIGS. 3 and 4, the gravity-balancing device according to the preferred embodiment thereof further includes a case 6. The case 6 is a substantially U-shaped member for correspondingly assembling to the inner side of the mounting bracket 1, so as to cover the spiral elastic element 2 and the winding element 3 in between the case 6 and the mounting bracket 1 and give the gravity-balancing device an esthetic appearance. The spindle 31 of the winding element 3 can be configured to extend through the case 6 to connect to the first end of the head roller 71 directly or indirectly via the coupled axle 5.

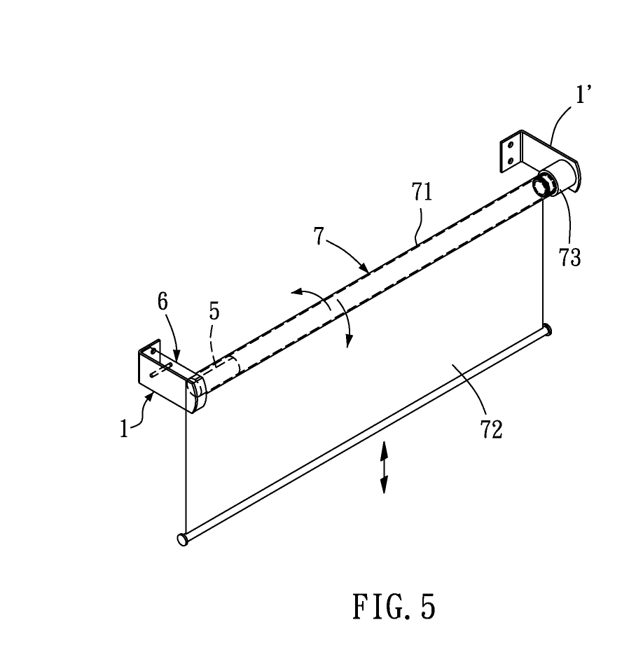

Please refer to FIGS. 4 and 5. The gravity-balancing device works with a general motor 73 mounted to the second end of the head roller 71 to provide the function of balancing a gravitational force that downwardly lowers or unwinds the shade fabric 72 of the electric roller shade 7. More specifically, the winding element 3 is synchronously brought to rotate when the head roller 71 of the electric roller shade 7 is driven by the motor 73 to rotate and vertically lower the shade fabric 72, such that the reel 31 with the connecting end 22 of the spiral elastic element 2 connected thereto pulls the elastic strip or string of the spiral elastic element 2 and winds the same therearound. At this point, due to a spring force of the elastic strip or string, the spiral elastic element 2 generates a counter-force to the winding element 3 and the head roller 71. As a result, the head roller 71 has an upward winding force that balances or offsets the gravitational force lowering the shade fabric 72, enabling a balance between the weight of the shade fabric 72 and the counter-force of the spiral elastic element 2. Thus, the shade fabric 72 can stay at a desired height position without lowering further at the instant the motor 73 stops operating. On the other hand, when the motor 73 drives the head roller 71 to rotate reversely and lift the shade fabric 72, the spiral elastic element 2 is released from the winding element 3 and rewound, so that the shade fabric 72 is rewound around the head roller 71 and lifted to a higher position.

With the gravity-balancing device for electric roller shade lifting system according to the present invention, it is able to balance the force for lifting (i.e. rewinding) the shade fabric 72 of the electric roller shade 7 and the gravitational force lowering (i.e. unwinding) the shade fabric 72. That is, with the gravity-balancing device, the shade fabric 72 would not keep lowering due to its own weight when the motor 73 is stopped and can be rewound without the need of a relatively large upward winding force. Therefore, the motor 73 for the electric roller shade 7 can be any other type instead of an expensive servomotor to give more flexibility in designing the roller shade. Further, by using the general motor 73 that requires only reduced power consumption, it is able to save the cost for electrical energy and extend the service life of the motor.

With the above arrangements, the gravity-balancing device of the present invention is novel, improved and industrially practical for use. The present invention is novel and improved because the gravity-balancing device can generate a counter-force for upward rotating the head roller of the electric roller shade and the motor for the electric roller shade can therefore drive the head roller to rotate reversely and lift the shade fabric with a reduced torque output to save power and extend the service life of the motor; and the shade fabric can stay at a desired height position without lowering further when the motor stops operating. The present invention is industrially practical for use because its structural characteristics and technical measures would doubtlessly meet the demands in the current market.

The present invention has been described with a preferred embodiment thereof and it is understood that many changes and modifications in the described embodiment can be carried out without departing from the scope and the spirit of the invention that is intended to be limited only by the appended claims.

1. A gravity-balancing device for electric roller shade lifting system being mounted to a first end of a roller of an electric roller shade, comprising:
a mounting bracket;
a spiral elastic element mounted to a first supporting section of the mounting bracket; and
a winding element rotatably mounted to a second supporting section of the mounting bracket,
wherein the spiral elastic element has a fixing end connected to the first supporting section and a connecting end connected to the winding element, such that the spiral elastic element is configured to be pulled outward and wound around the winding element when the winding element rotates, and
wherein the winding element is located adjacent to the spiral elastic element and connected. to the first end of the roller.

2. The gravity-balancing device as claimed in claim 1, wherein the winding element includes a spindle and a reel; the spindle being rotatably mounted on the second supporting section of the mounting bracket, and the reel being connected to the spindle.

3. The gravity-balancing device as claimed in claim 2, wherein the connecting end of the spiral elastic element is connected to the reel of the winding element.

4. The gravity-balancing device as claimed in claim 2, further comprising two stoppers clamped to two opposite lateral sides of the spiral elastic element.

5. The gravity-balancing device as claimed in claim 4, further comprising a coupled axle having an end connected to the winding element and another opposite end connected to the first end of the head roller.

6. The gravity-balancing device as claimed in claim 5, further comprising a case assembled to the mounting bracket to cover the spiral elastic element and the winding element in between the case and the mounting bracket; and the spindle of the winding element being extended through the case to connect to the first end of the head roller.

7. The gravity-balancing device as claimed in claim 6, wherein the first supporting section has a first shaft connected thereto and the second supporting section has a second shaft connected thereto; the fixing end of the spiral elastic element being connected to the first shaft, and the winding element being rotatably fitted around the second shaft.
